(19) United States
(12) Patent Application Publication
(10) Pub. No.: US 2018/0062399 A1
(43) Pub. Date: Mar. 1, 2018

(54) Power supply system

(71) Applicant: Battery-Biz Inc., Camarillo, CA (US)

(72) Inventors: Jack DeBiasio, Camarillo, CA (US); Wasi Khursheed, Camarillo, CA (US); Ron Wood, Camarillo, CA (US); Ophir Marish, Camarillo, CA (US)

(73) Assignee: Battery-Biz Inc., Camarillo, CA (US)

(21) Appl. No.: 15/506,729

(22) PCT Filed: Dec. 1, 2016
(86) PCT No.: PCT/IB2016/057236

§ 371 Date: Feb. 25, 2017

Related U.S. Application Data
(60) Provisional application No. 62/428,521, filed on Nov. 30, 2016.
(60) Provisional application No. 62/310,629, filed on Mar. 18, 2016.

(51) Int. Cl. H02J 7/00; H02J 7/02

(52) U.S. Cl. CPC H02J 7/0003; H02J 7/02; H02J 7/0045

(57) ABSTRACT

A device has a first port and a second port and circuitry, the first port having at least a signaling pin, a first power pin, a ground pin, and a second power pin. The first port is connected to a power delivery device. Circuitry is powered by means of the first power pin and the ground pin. A power request is passed to the power delivery device, requesting a second power level defining at least a predetermined voltage and a predetermined current supply capability. This power is delivered through a second port to a rechargeable consumer electronic device. The rechargeable consumer electronic device is charged at the predetermined voltage and with respect to the predetermined current supply capability.

### BACKGROUND

It is not easy to provide charging currents that are well matched in a versatile way to the needs of a variety of rechargeable consumer electronic devices.

FIG. 1 shows a charging approach according to the prior art including voltage delivery device 21 along with power tip 68 being used for charging of consumer electronic device 69. Voltage delivery device 21 has a housing 24. Extending from the housing 24 is a power cable 23 with plug 22 for connection to an AC power outlet. Extending from the housing 24 is a second cable 26 with conductors 41, 42, and 43, which leads to connector 27. Power tip 68 has a housing 28. Housing 28 has a first port 31 and a second port 30. First port 31 connects with connector 27. Second port 30 has two conductors 35, 36. A typical physical configuration is a barrel plug with a center conductor and a shell. Consumer electronic device 69 has a housing 38 and a rechargeable battery 70. A port 37 mates with port 30, with first and second conductors 39, 40. A typical physical configuration is a barrel jack with a center conductor and a shell conductor, disposed to mate with the barrel plug of port 30.

Power tip 68 is one of a plurality of power tips, each designed for compatibility with a respective consumer electronic device 69 which is one of a plurality of consumer electronic devices. Thus for example a first consumer electronic device may have a port 37 which receives a plug that is 3 millimeters in diameter and the electronic device may require a charging voltage of 19 volts. A second consumer electronic device may have a port 37 which receives a plug that is 4 millimeters in diameter and the electronic device may require a charging voltage of 12 volts. Several power tips may be available to the human users, a first one of which has a plug that is 3 millimeters in diameter and that has a physical feature 33 nearby to conductors 34 and 32, and a second one of which has a plug that is 4 millimeters in diameter and that has no physical feature 33 nearby to conductors 34 and 32.

As mentioned above, cable 26 has first, second, and third conductors 41, 42, and 43. First conductor 41 is, in this embodiment, defined as a ground line. Third conductor 43 is, in this embodiment, defined as a positive line. Second conductor 42 is, in this embodiment, a signal line about which more will be said. Second conductor 42 is connected with switch 29 which engages with physical feature 33 if present.

The human user checks the make and model of consumer electronic device 69 and selects a power tip 68 with a plug at port 30 which matches the jack at port 37. The match takes into account at least the diameter of the barrel jack and plug and may also take into account other dimensional factors. The selection of the power tip 68 also takes into account the charging voltage which the consumer electronic device is designed to receive for use in charging its battery 70. In the embodiment shown here, a power tip 68 that is supposed to provide 19 volts will have a feature 33. On the other hand in the embodiment shown here, a power tip 68 that is supposed to provide 12 volts will have no feature 33.

With AC power provided to plug 22, voltage delivery device 21 is designed so that it will deliver 12 or 19 volts at conductor 43 depending upon whether continuity is detected (19 volts) or is not detected (12 volts) between conductors 41 and 42.

In this way, with a particular power tip 68 correctly selected to match a particular consumer electronic device 69, charging current at a desired voltage is supplied on conductor 43 to conductor 32, thence to conductor 36, and thence to conductor 40. Circuitry in the consumer electronic device, omitted for clarity in FIG. 1, conditions the charging current so as to accomplish appropriate charging of the battery 70. A return conductor 39, defined here as ground, connects through the barrel plug to conductor 35, thence to conductor 34, thence to conductor 41, completing a charging circuit with voltage delivery device 21.

It would be helpful if a way could be devised in which the charging current could be more precisely tailored to the needs of a particular consumer electronic device 69. It would also be helpful if a way could be devised that is able to be used with legacy power tips 68 with which a human user is already familiar. The human user may have become familiar with the particular power tip 68, among many varied power tips 68, that matches the needs of a particular consumer electronic device 69 among many varied consumer electronic devices 69. Such familiarity on the part of the human user may permit a comfortable migration for the human user from a legacy approach to a more precisely tailored approach.

### DESCRIPTION OF THE DRAWING

The invention will be described with respect to a drawing in several figures, of which:

FIG. 1 shows a prior-art charging approach;

FIG. 2 shows a first embodiment according to the invention; and

FIG. 3 shows a second embodiment according to the invention.

### DETAILED DESCRIPTION

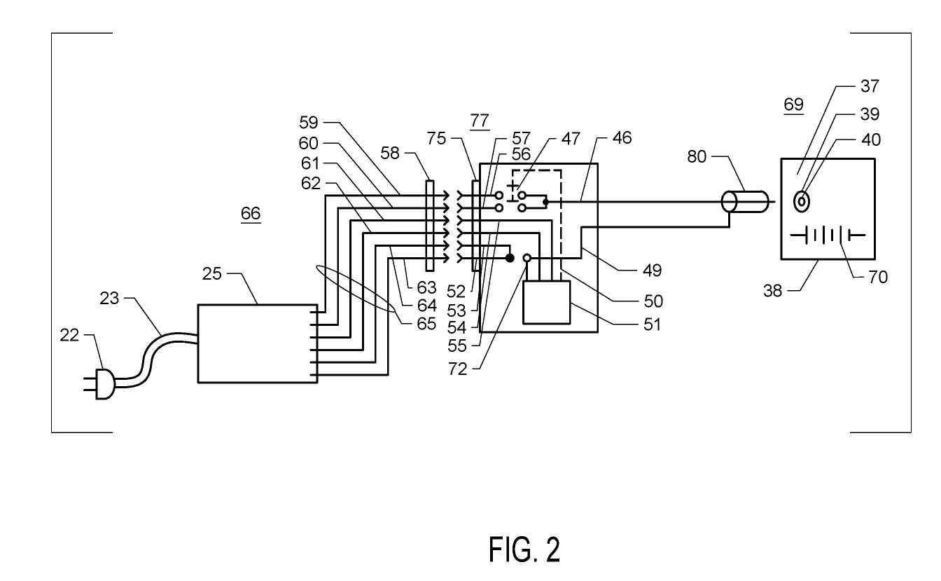

A first embodiment of the invention is shown in FIG. 2. A charging current delivery device 66 and a two-port device 77 according to this embodiment are shown. Current delivery device 66 has a housing 25. Extending from the housing 25 is a power cable 23 with plug 22 for connection to an AC power outlet. The power cable 23 and plug 22 for this embodiment of the invention are very similar to the power cable 23 and plug 22 for the legacy approach. The alert reader will appreciate that this similarity is due to the fact that the AC power outlet to which a legacy voltage delivery device 21 might be connected is the same type of AC power outlet to which a current delivery device 66 might be connected.

The two port device 77 has a first port 75 and a second port 80. First port 75 is mechanically and electrically disposed to mate with connector 58. First port 75 and connector 58 are depicted with six conductors but in some variants there may be other additional conductors. Such possible additional conductors, if any, are omitted for clarity in FIG. 2. Second port 80 is mechanically and electrically disposed to mate with a particular consumer electronic device 69 among many varied consumer electronic devices 69. Second port 80 has two conductors 49, 46. A typical configuration for second port 80 is a barrel plug with a center conductor and a shell. Consumer electronic device 69 has a housing 38 and a rechargeable battery 70. A third port 37 on consumer electronic device 69 mates with second port 80, having second conductors 39, 40. The typical physical configuration of third port 37 is a barrel jack with a center conductor and a shell conductor, disposed to mate with second port 80.

Second port 80 has first and second conductors 49 and 46. First conductor 49 is, in this embodiment, defined as a ground line. Second conductor 46 is, in this embodiment, defined as a positive line.

In this first embodiment according to the invention, two-port device 77 is designed for use with a particular consumer electronic device 69 and may be purchased at a later time for such use or replacement. Two-port device 77 in this embodiment is characterized by a charging voltage and physical compatibility with a particular consumer electronic device 69.

With AC power provided to plug 22, current delivery device 66 is designed so that it will deliver a modest amount of electrical power on conductor 61 relative to a conductor 63 or 64 defined as a ground return. In a typical embodiment this modest amount of electrical power will be about five volts, and the voltage delivery device will only be able to provide at most perhaps some predetermined current value in the range of 0.5 to 1.5 amperes. The voltage delivery device 66 also has a conductor 62 which carries out a rather sophisticated signaling function about which more will be said later.

Two-port device 77 contains circuitry 51 which requires a modest amount of electrical power to be able to carry out its functions as will be discussed. When two-port device 77 is connected with current delivery device 66, at a time when current delivery device is powered, then the conductor 61 makes the modest amount of electrical power available via line 55 to the circuitry 51. Return line 72 connects with ground return 52 or 53, which connects in turn respectively with ground return 63 or 64. This permits the circuitry 51 to be powered up. Circuitry 51 passes a message to current delivery device 66 containing a particular voltage and current profile appropriate for the particular consumer electronic device 69. The message may be characterized as having a data rate exceeding 1000 bits per second, that is, exceeding 1 kilobits per second.

The embodiment shown in FIG. 2 assumes that current delivery device 66 receives power from an AC outlet via plug 22 and cable 23. It will be appreciated, however, that variations are possible. For example power might be received from a 12-volt DC outlet in a motor vehicle using a suitable plug 22. Or in another variation, current delivery device contains a substantial battery providing power for the functions of the current delivery device 66. The battery might be rechargeable or might be disposable.

In this embodiment, current delivery device 66 responds to the passed message or messages by delivering charging current on line 59 or line 60 (or both). It delivers the charging current at the requested voltage and makes the charging current available at the current level that was indicated by the circuitry 51. Thus in the example just given the current delivery device might provide up to 4 amperes on both lines 59 and 60 at 19 volts, thus making as much as 86 watts of charging power available.

Thus, in response to a particular two-port device 77 connecting a particular consumer electronic device 69 to charging current delivery device 66, charging current at a desired voltage and level of available current is supplied on conductors 59 or 60 (or both) to conductors 56 or 57 (or both), through switch 47, thence to conductor 46, thence to second port 80. Circuitry in the consumer electronic device, omitted for clarity in FIG. 2, conditions the charging current so as to accomplish appropriate charging of the battery 70. A return conductor 39, defined here as ground, connects through the barrel plug to conductor 49, thence to conductors 52 or 53 (or both), thence to conductors 63 or 64 (or both), completing a charging circuit with current delivery device 66.

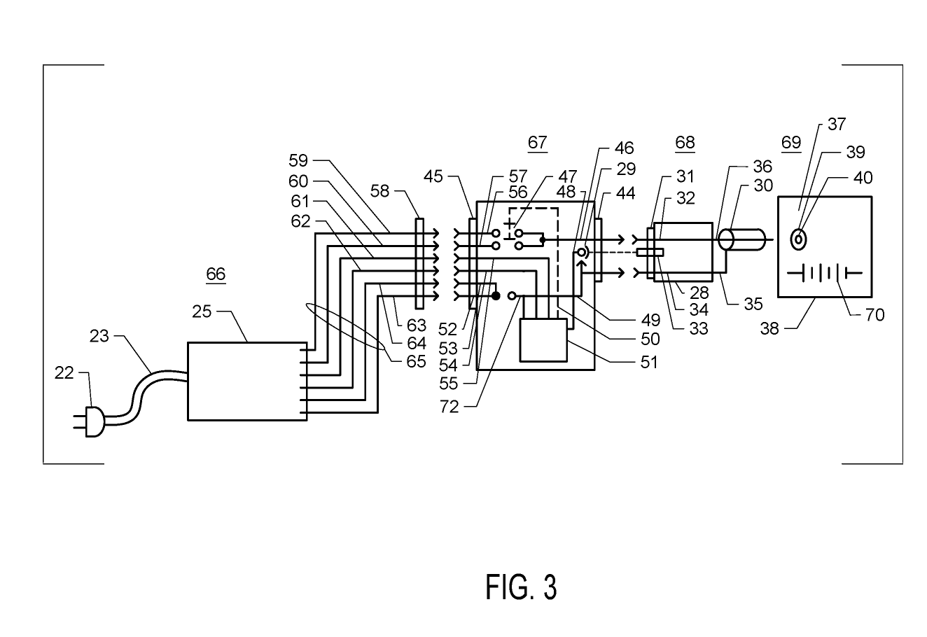

Switch 47, if present, is controlled by control line 50 by circuitry 51. In a typical embodiment, switch 47 if present is one or two MOSFETs providing solid-state switching. Alternatively conductors 56 and 57 may be permanently connected with conductor 46. Thus, in FIG. 2 and in FIG. 3, it will be appreciated that the connection at switch 47 may also be straight wire.

Turning now to FIG. 3, what is shown is a charging approach according to a second embodiment of the invention. The approach includes charging current delivery device 66 and adapter device 67 along with power tip 68 being used for charging of consumer electronic device 69. Current delivery device 66 has a housing 25. Extending from the housing 25 is a power cable 23 with plug 22 for connection to an AC power outlet. In a typical embodiment the power cable 23 and plug 22 for the approach according to the invention is very similar to the power cable 23 and plug 22 for the legacy approach. The alert reader will appreciate that this similarity is due to the fact that the AC power outlet to which a legacy voltage delivery device 21 might be connected is the same type of AC power outlet to which a current delivery device 66 might be connected.

Extending from the housing 25 is a second cable 65 with conductors 59, 60, 61, 62, 63 and 64, which leads to connector 58.

The attention of the reader is now respectfully directed to adapter device 67, shown in FIG. 3. Adapter device 67 has a first port 45 and a second port 44. First port 45 is mechanically and electrically disposed to mate with connector 58. First port 45 and connector 58 are depicted with six conductors but in some variants there may be other additional conductors. Such possible additional conductors, if any, are omitted for clarity in FIG. 3. Second port 44 is mechanically and electrically disposed to mate with port 31 of power tip 68.

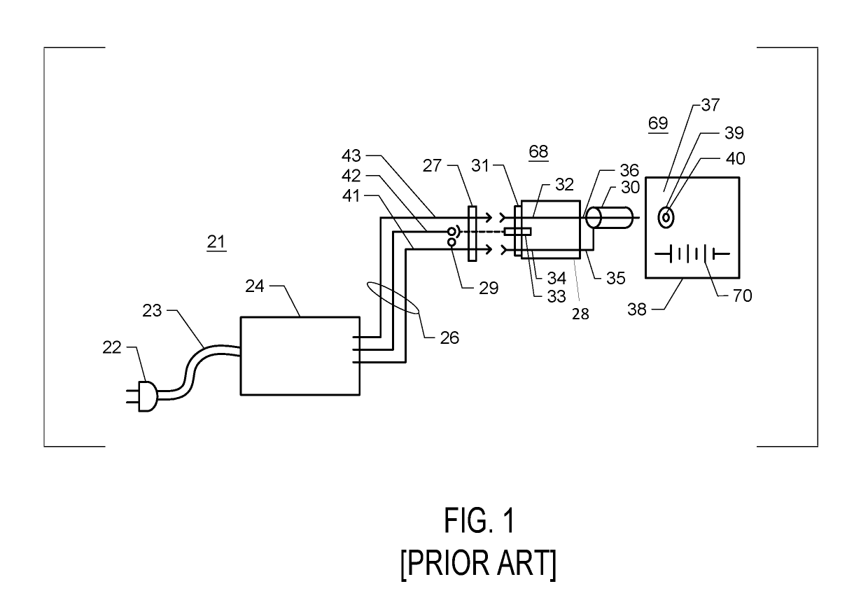

It will be helpful to discuss the role that power tip 68 plays in this charging approach. The human user may already have become familiar with the particular power tip 68, among many varied power tips 68, that matches the needs of a particular consumer electronic device 69 among many varied consumer electronic devices 69. This familiarity may be due to the human user having previously made use of the legacy approach of FIG. 1. The familiarity may be due in part to the availability of convenient resources such as web sites or user documentation that are intended to help the human user know which particular power tip 68 is the correct one to be used with a particular consumer electronic device 69. The familiarity may be due to a simple fact that a particular power tip 68 is labeled with the make and model of a particular matching consumer electronic device 69.

As mentioned above in the discussion relating to FIG. 1, the power tip 68 as shown in FIG. 3 likewise has the housing 28. Housing 28 has the first port 31 and the second port 30. First port 31 connects with connector 44. As mentioned above, second port 30 has two conductors 35, 36. As discussed, the typical physical configuration is the barrel plug with the center conductor and the shell. As discussed above, consumer electronic device 69 has the housing 38 and the rechargeable battery 70. A port 37 mates with port 30, with first and second conductors 39, 40. As mentioned, the typical physical configuration is the barrel jack with the center conductor and the shell conductor, disposed to mate with the barrel plug of port 30.

As mentioned above, power tip 68 is one of a plurality of power tips, each designed for compatibility with a respective consumer electronic device 69 which is one of a plurality of consumer electronic devices. Thus for example a first consumer electronic device may have a port 37 which receives a plug that is 3 millimeters in diameter and the electronic device may require a charging voltage of 19 volts. A second consumer electronic device may have a port 37 which receives a plug that is 4 millimeters in diameter and the electronic device may require a charging voltage of 12 volts. Several power tips may be available to the human users, a first one of which has a plug that is 3 millimeters in diameter and that has a feature 33 nearby to conductors 34 and 32, and a second one of which has a plug that is 4 millimeters in diameter and that has no feature at the area 33 between conductors 34 and 32.

Returning to the adapter device 67, it will be recalled that the adapter device has a second port 44. Second port 44 has first and second conductors 49 and 46. First conductor 49 is, in this embodiment, defined as a ground line. Second conductor 46 is, in this embodiment, defined as a positive line. There is also a line 48 which is a signal line about which more will be said. Line 48 connects with switch 29 which engages with feature 33 if present.

Just as with the legacy approach, in this second embodiment according to the invention, the human user checks the make and model of consumer electronic device 69 and selects a power tip 68 with a plug at port 30 which matches the jack at port 37. The match takes into account at least the diameter of the barrel jack and plug and may also take into account other dimensional factors. The selection of the power tip 68 also takes into account the charging voltage which the consumer electronic device is designed to receive for use in charging its battery 70. With power tips 68 as discussed here, a power tip 68 that is supposed to provide 19 volts will have a feature 33, while a power tip 68 that is supposed to provide 12 volts will have no feature 33.

With AC power provided to plug 22, current delivery device 66 is designed so that it will deliver a modest amount of electrical power on conductor 61 relative to a conductor 63 or 64 defined as a ground return. In a typical embodiment this modest amount of electrical power will be about five volts, and the voltage delivery device will only be able to provide at most perhaps some predetermined current value in the range of 0.5 to 1.5 amperes. The voltage delivery device 66 also has a conductor 62 which carries out a rather sophisticated signaling function about which more will be said later.

Adapter device 67 contains circuitry 51 which requires a modest amount of electrical power to be able to carry out its functions as will be discussed. When adapter device 67 is connected with current delivery device 66, at a time when current delivery device is powered, then the conductor 61 makes the modest amount of electrical power available via line 55 to the circuitry 51. Return line 72 connects with ground return 52 or 53, which connects in turn respectively with ground return 63 or 64. This permits the circuitry 51 to be powered up. The powered behavior of circuitry 51 will be discussed in more detail momentarily.

The embodiment shown in FIG. 3 assumes that current delivery device 66 receives power from an AC outlet via plug 22 and cable 23. It will be appreciated, however, that variations are possible. For example power might be received from a 12-volt DC outlet in a motor vehicle using a suitable plug 22. Or in another variation, current delivery device contains a substantial battery providing power for the functions of the current delivery device 66. The battery might be rechargeable or might be disposable.

Returning to the discussion of the powered behavior of circuitry 51, there is a sense line 48. If a power tip 68 is plugged into the port 44, then sense line permits circuitry 51 to determine whether there is or is not continuity between conductors 48 and 49, that is, whether feature 33 is present and engages with switch 29 to connect conductor 48 and conductor 49 to conductor 34. Circuitry 51 thus determines whether a charging current of 12 or 19 volts will be provided to the power tip 68, depending upon whether continuity is detected (19 volts) or is not detected (12 volts) between conductors 48 and 49.

The alert reader will appreciate that when it is described that switch 29 is or is not engaged with feature 33, which does or does not provide continuity between conductors 49 and 48, there is another way to achieve a result that is functionally identical, namely that instead of a switch 29 and a physical feature 33, the tip might have electrical continuity or the lack of continuity at a corresponding third pin in the connector that includes conductors 49 and 48.

Until this point nothing has been said about conductor 54 from circuitry 51. Conductor 54 connects with conductor 62 of cable 65 which reaches current delivery device 66. Importantly, depending upon the continuity condition detected at conductor 48, circuitry 51 will carry out a sophisticated exchanging of a message or messages along conductor 54 and along conductor 62 with the current delivery device 66. The messages may be characterized as having a data rate exceeding 1000 bits per second, that is, exceeding 1 kilobits per second. Circuitry 51 will exchange a message or messages indicative of at least two desired qualities for a charging current. One quality being communicated is the voltage being supplied, such as the 12 or 19 volts mentioned above. In addition, a second quality being communicated may be the current capable of being supplied, and perhaps the number of power conductors to be employed in the delivery of the charging current. For example the circuitry 51 may request 19 volts at up to 4 amperes, meaning that as much as 86 watts of charging power may be delivered.

In this embodiment, current delivery device 66 responds to the passed message or messages by delivering charging current on line 59 or line 60 (or both). It delivers the charging current at the requested voltage and makes the charging current available at the current level that was negotiated with the circuitry 51. Thus in the example just given the current delivery device might provide up to 4 amperes on both lines 59 and 60 at 19 volts, thus making as much as 86 watts of charging power available.

In this way, with a particular power tip 68 correctly selected to match a particular consumer electronic device 69, charging current at a desired voltage and level of available current is supplied on conductors 59 or 60 (or both) to conductors 56 or 57 (or both), through switch 47, thence to conductor 46, thence to conductor 32, thence to conductor 36, and thence to conductor 40. Circuitry in the consumer electronic device, omitted for clarity in FIG. 3, conditions the charging current so as to accomplish appropriate charging of the battery 70. A return conductor 39, defined here as ground, connects through the barrel plug to conductor 35, thence to conductor 34, thence to conductor 49, thence to conductors 52 or 53 (or both), thence to conductors 63 or 64 (or both), completing a charging circuit with current delivery device 66.

Switch 47, if present, is controlled by control line 50 by circuitry 51. In a typical embodiment, switch 47 if present is one or two MOSFETs providing solid-state switching. Alternatively conductors 56 and 57 may be permanently connected with conductor 46. Thus, in FIG. 2 and in FIG. 3, it will be appreciated that the connection at switch 47 may also be straight wire.

The availability of two distinct power conductors 59 and 60, and the availability of two distinct ground returns 63 and 64, offers some advantages over a legacy approach in which only single conductors (such as 41 and 43 in FIG. 1) are available. For example when relatively high currents such as the above-mentioned 4 amperes are being passed along cable 65, the current can be divided between the two conductors (59 and 60 or 63 and 64), thus reducing the resistive losses in the cable 65 and its connector pins. A further advantage is redundancy in the sense that if one of the conductors 59 or 60 or 63 or 64 were to fail, the system might nonetheless be able to function, even if perhaps at a lower current level.

The power conductor 61 is, importantly, not the same as the power conductor or conductors 59 and/or 60. They have non-identical functions and very often will carry non-identical voltages. There will, for example, be times at which there is power on conductor 61 but not on conductors 59 or 60.

Having discussed this second embodiment from the point of view of its hardware, it may be helpful to discuss the sequences of events that may take place during use of the adapter device 67 by the human user. It will be recalled that the adapter device 67 has a first port 45 and a second port 44 and circuitry 51. The the first port 45 comprises a connector with at least a first signaling pin 54, a first power pin 55, a ground pin 52 and/or 53, and a second power pin 56 and/or 57, the first signaling pin 54 distinct from the ground pin 52 and/or 53, the first power pin 55 distinct from the first signaling pin 54 and distinct from the ground pin 52 and/or 53, the second power pin 56 and/or 57 distinct from the first power pin 55 and distinct from the first signaling pin 54 and distinct from the ground pin 52 and/or 53. The second port 44 comprises a connector with at least a third power pin 46 and a fourth power pin 49 (here understood as a ground return) and a second signaling pin 48. The power tip 68 has a third port 31 and a fourth port 30, the third port 31 having pins disposed to mate with the third power pin 46 and the fourth power pin 49 and the second signaling pin 48, the fourth port 30 having a fifth pin 36 and a sixth pin 35.

A first step is that the human user connects one of the plurality of tips 68 to the second port 44 of the device 67. The circuitry 51 has continuity with a signal from the tip 68 by means of the feature 33, the signal from the tip 68 indicative of a desired voltage for a rechargeable consumer electronic device 69.

Another step is that the human user connects the first port 45 of the adapter device 67 to a power delivery device 66 by means of connector 58. The circuitry 51 receives a first power level by means of the first power pin 55 and the ground pin or pins 52 and/or 53, and powering the circuitry 51 by means of this first power level. The circuitry 51 having been powered up, it passes a power request to the power delivery device 66, the power request indicative of a second power level such as the 12-volt or 19-volt charging current at some level of available current, the power request communicated by means of the signaling pin 54, the power request comprising at least some bits of information communicated at a data rate exceeding 1000 bits per second.

The adapter device 67 completes a connection between the second power pin 56 and/or 57 and the third power pin 46. It also completes a connection between the ground pin 52 and/or 53 and the fourth power pin 49. The adapter device thus receives a charging current at the predetermined voltage and the predetermined current supply capability at the second power pin 56 and/or 57 and the ground pin 52 and/or 53, and passing the charging current to the third power pin 46 and the fourth power pin 49. The fourth port 30 of the tip 68 is connected to a rechargeable consumer electronic device 69. The desirable result is that the rechargeable consumer electronic device is charged at the predetermined voltage and with respect to the predetermined current supply capability.

As discussed above, the first port 45 may further comprise a fifth power pin (one of pins 56 or 57), the step of completing a connection in response to the power response further comprises connecting the second power pin (one of pins 56 or 57) with the fifth power pin (the other of pins 56 or 57), whereby the charging current is passed partly on pin 56 and partly on the pin 57.

The sequence of events may be that the step of connecting the second port 44 to the tip 68 comes after the step of connecting the first port 45 to the power delivery device 66.

1. A method for use with a device having a first port and a second port and circuitry,
the first port comprising a connector with at least a signaling pin, a first power pin, a ground pin, and a second power pin, the signaling pin distinct from the ground pin, the first power pin distinct from the signaling pin and distinct from the ground pin, the second power pin distinct from the first power pin and distinct from the signaling pin and distinct from the ground pin,
the second port comprising a connector with at least a third power pin and a fourth power pin,
the method comprising the steps of:
connecting the first port to a power delivery device;
receiving a first power level by means of the first power pin and the ground pin, and powering the circuitry by means of this first power level;
by means of the circuitry, passing a power request to the power delivery device, the power request indicative of a second power level, the power request communicated by means of the signaling pin, the power request comprising at least some bits of information communicated at a data rate exceeding 1 kilobits per second;
the second power level defining at least a predetermined voltage and a predetermined current supply capability;
by means of the circuitry, receiving a power response from the power delivery device;
in response to the power response, completing a connection between the second power pin and the ground pin on the one hand, and the third power pin and the fourth power pin on the other hand;
receiving a charging current at the predetermined voltage and the predetermined current supply capability at the second power pin and the ground pin, and passing the charging current to the third power pin and the fourth power pin;
connecting the second port to a rechargeable consumer electronic device; and
charging the rechargeable consumer electronic device at the predetermined voltage and with respect to the predetermined current supply capability.

2. The method of claim 1 wherein the second port is a coaxial barrel plug.

3. The method of claim 1 wherein the first port further comprises a fifth power pin, and wherein the step of completing a connection in response to the power response further comprises connecting the second power pin with the fifth power pin, whereby the charging current is passed partly on the second power pin and partly on the fifth power pin.

4. The method of claim 1 wherein the step of connecting the second port to the rechargeable consumer electronic device comes after the step of connecting the first port to the power delivery device.

5. A power delivery apparatus, comprising:
a device having a first port and a second port at opposite ends of the device, the first port comprising a connector with at least a signaling pin, a first power pin, a ground pin, and a second power pin, the signaling pin distinct from the ground pin, the first power pin distinct from the signaling pin and distinct from the ground pin, the second power pin distinct from the first power pin and distinct from the signaling pin and distinct from the ground pin, the second port comprising a connector with at least a third power pin and a fourth power pin;
a power supply comprising a third port and a power cord connected thereto and having an AC plug at an opposite end of the power cord.

6. The power delivery apparatus of claim 5 wherein the second port is a coaxial barrel plug.

7. The apparatus of claim 5 wherein the first port further comprises a fifth power pin, and wherein the step of completing a connection in response to the power response further comprises connecting the second power pin with the fifth power pin, whereby the charging current is passed partly on the second power pin and partly on the fifth power pin.

8. A method for use with a device having a first port and a second port and circuitry,
the first port comprising a connector with at least a first signaling pin, a first power pin, a ground pin, and a second power pin, the first signaling pin distinct from the ground pin, the first power pin distinct from the first signaling pin and distinct from the ground pin, the second power pin distinct from the first power pin and distinct from the first signaling pin and distinct from the ground pin,
the second port comprising a connector with at least a third power pin and a fourth power pin and a second signaling pin,
the method for use with a plurality of tips, each tip having a third port and a fourth port, the third port having pins disposed to mate with the third power pin and the fourth power pin and the second signaling pin, the fourth port having a fifth pin and a sixth pin;
the method comprising the steps of:
connecting one of the plurality of tips to the second port of the device;
at the circuitry, receiving a signal from the tip by means of the second signaling pin, the signal from the tip indicative of a desired voltage for a rechargeable consumer electronic device;
connecting the first port to a power delivery device;
receiving a first power level by means of the first power pin and the ground pin, and powering the circuitry by means of this first power level;
by means of the circuitry, passing a power request to the power delivery device, the power request indicative of a second power level, the power request communicated by means of the signaling pin, the power request comprising at least some bits of information communicated at a data rate exceeding 1 kilobits per second;
the second power level defining at least the voltage indicated by the signal from the tip and a predetermined current supply capability;
by means of the circuitry, receiving a power response from the power delivery device;
in response to the power response, completing a connection between the second power pin and the ground pin on the one hand, and the third power pin and the fourth power pin on the other hand;
receiving a charging current at the predetermined voltage and the predetermined current supply capability at the second power pin and the ground pin, and passing the charging current to the third power pin and the fourth power pin;
connecting the fourth port of the tip to a rechargeable consumer electronic device; and
charging the rechargeable consumer electronic device at the predetermined voltage and with respect to the predetermined current supply capability.

9. The method of claim 8 wherein the fourth port is a coaxial barrel plug.

10. The method of claim 8 wherein the first port further comprises a fifth power pin, and wherein the step of completing a connection in response to the power response further comprises connecting the second power pin with the fifth power pin, whereby the charging current is passed partly on the second power pin and partly on the fifth power pin.

11. The method of claim 8 wherein the step of connecting the second port to the tip comes after the step of connecting the first port to the power delivery device.

12. A power delivery apparatus comprising:
a device having a first port and a second port at opposite ends of the device, the first port comprising a connector with at least a first signaling pin, a first power pin, a ground pin, and a second power pin, the first signaling pin distinct from the ground pin, the first power pin distinct from the first signaling pin and distinct from the ground pin, the second power pin distinct from the first power pin and distinct from the first signaling pin and distinct from the ground pin;
the second port comprising a connector with at least a third power pin and a fourth power pin and a second signaling pin; and
a plurality of tips, each tip having a third port and a fourth port, the third port having pins disposed to mate with the third power pin and the fourth power pin and the second signaling pin, the fourth port having a fifth pin and a sixth pin.

13. The power delivery apparatus of claim 12 wherein the fourth port is a coaxial barrel plug.

14. The apparatus of claim 12 wherein the first port further comprises a fifth power pin, and wherein the step of completing a connection in response to the power response further comprises connecting the second power pin with the fifth power pin, whereby the charging current is passed partly on the second power pin and partly on the fifth power pin.
